(19) United States
(12) Patent Application Publication
(10) Pub. No.: US 2009/0015594 A1
(43) Pub. Date: Jan. 15, 2009

(54) AUDIO SIGNAL PROCESSING DEVICE AND COMPUTER PROGRAM FOR THE SAME

(76) Inventor: Teruo Baba, Saitama (JP)

Correspondence Address: YOUNG & THOMPSON, 209 Madison Street, Suite 500, ALEXANDRIA, VA, 22314, US

(21) Appl. No.: 11/909,019

(22) PCT Filed: Mar. 15, 2006
(86) PCT No.: PCT/JP2006/305122

§ 371 Date: Nov. 6, 2007

(30) Foreign Application Priority Data
Mar. 18, 2005 (JP) 2005079101

(51) Int. Cl. G09G 5/00

(52) U.S. Cl. 345/619

(57) ABSTRACT

A sound signal processing apparatus includes: an obtaining unit which obtains a sound signal discriminated for each frequency band; a color assignment unit which assigns color data, different for each frequency band, to the obtained sound signal; a luminance change unit which generates data including a changed luminance of the color data, base on a level for each frequency band of the sound signal; a color mixing unit which generates data obtained by totalizing data generated by the luminance change unit in all the frequency bands; and a display image generating unit which generates image data for display on an image display device from data generated by the color mixing unit. Because of mixing the data for each frequency band and displaying the data as the single image, the sound signal processing apparatus can display the frequency characteristics of plural channels with using the image of small number. Thereby, the user can easily understand the characteristics of plural channels based on the displayed image.

### TECHNICAL FIELD

The present invention relates to a sound signal processing apparatus for processing of a sound signal outputted from a speaker.

### BACKGROUND TECHNIQUE

Conventionally, a sound pressure level and frequency characteristics of a sound signal outputted from a speaker is displayed on a monitor as an image. By recognizing a sound field characteristics based on the image displayed on the monitor, a user can effectively adjust the frequency characteristics and the sound pressure level.

For example, Patent Reference-1 discloses such a technique that a sound signal is divided into plural frequency bands and an image of expressing the level for each frequency band by color density and hue is displayed. Specifically, each frequency band is expressed by a distance from a predetermined point on a screen, and is displayed so that the color and a luminance change for each frequency. Moreover, Patent Reference-2 discloses such a technique that the level for each frequency band is displayed by making the sound signal divided into plural frequency bands correspond to a specific color and making left and right channels correspond to left and right sides of the screen.

Patent Reference-1: Japanese Patent Application Laid-open under No. 11-225031

Patent Reference-2: Japanese Patent Application Laid-open under No. 8-294131

Since connection of the respective channels forms the sound field at the time of multi-channel reproduction with using plural speakers, automatic or manual correction of the frequency characteristics and reverberation characteristics is executed so that the characteristics of the speaker of each channel and the reproduction sound field become same. At this time, it is preferable that the user can confirm states before and after the correction on the monitor.

However, when the techniques disclosed in the above Patent References-1 and 2 are applied to the multi-channel reproduction in this manner, information included in the displayed image becomes extremely large, and it is sometimes difficult to recognize the inter-channel characteristics at one time. Thereby, the user having little technical knowledge is forced to understand the display image, which problematically sometimes gives the user burden.

### DISCLOSURE OF INVENTION

### Problem to be Solved by the Invention

The present invention has been achieved in order to solve the above problem. It is an object of this invention to provide a sound signal processing apparatus capable of displaying characteristics of a sound signal in plural channels as an image for a user to easily understand.

### Means for Solving the Problem

According to one aspect of the present invention, there is provided a sound signal processing apparatus, including: an obtaining unit which obtains a sound signal discriminated for each frequency band; a color assignment unit which assigns color data, different for each frequency band, to the obtained sound signal; a luminance change unit which generates data including a changed luminance of the color data, base on a level for each frequency band of the sound signal; a color mixing unit which generates data obtained by totalizing data generated by the luminance change unit in all the frequency bands; and a display image generating unit which generates image data for display on an image display device from data generated by the color mixing unit.

The above sound signal processing apparatus assigns the different color data to the sound signal discriminated for each frequency band, and changes the luminance of the color data on the basis of the level for each frequency band of the sound signal. Then, the sound signal processing apparatus totalizes the data including the changed luminance in all the frequency bands, and generates the image data for display the totalized data on the image display device. Thereby, since the frequency characteristics for each frequency band are displayed by a convenient image, the user can easily recognize the frequency characteristics of the sound signal by seeing the displayed image.

In a manner of the above sound signal processing apparatus, when the level for each frequency band of the sound signal is same, the color assignment unit may set the color data so that data obtained by totalizing all the color data shows a specific color. Moreover, the image display device may simultaneously display the image data and the specific color. Thereby, the user can easily recognize that the frequency characteristics of the respective frequency bands are flat.

In another manner of the above sound signal processing apparatus, the color assignment unit may set the color data so that color variation of the color data corresponds to high/low of the frequency of the frequency band. Namely, the color assignment unit associates high/low (long/short of wavelength) of the frequency of the sound signal and the color variation (long/short of light wavelength) on the basis of the sound wave length and the light wavelength, and assigns the color. Thereby, the user can viscerally recognize the frequency characteristics.

In an example, the luminance change unit may change the luminance of the color data in consideration of visual characteristics of a human. The reason will now be described. Since the human is sensitive to a hue (relative color difference), it becomes possible that a difference of the micro frequency characteristics is recognized as a large difference if the sensitive luminance change is given to the frequency characteristics.

In still another manner of the above sound signal processing apparatus, the obtaining unit may obtain the sound signal discriminated for each frequency band to each of output signals outputted from a speaker. The color assignment unit may assign the color data to each sound signal outputted from the speaker. The luminance change unit may generate data including the changed luminance of the color data, based on each level of the sound signal outputted from the speaker. The color mixing unit may generate data obtained by totalizing the output signal outputted from the speaker in all the frequency bands. The display image generating unit may generate the image data so that the data generated by the color mixing unit to each output signal outputted from the speaker is simultaneously displayed on the image display device.

In this manner, the sound signal processing apparatus obtains the output signal outputted from the speaker, i.e., the data of the plural channels, and displays the data obtained by processing each of the data. Specifically, the sound signal processing apparatus does not display all of the frequency characteristics for each channel frequency band, and does display, for each channel, the image formed by mixing the data for each frequency band. Thereby, even if all of the measurement results of the plural channels are simultaneously displayed, the displayed image is convenient. Therefore, the burden necessary for the user to understand the image can be reduced.

In a preferred example, the display image generating unit may generate the image data in which at least one of a luminance, an area and a measure of the image data displayed on the image display device is set, in correspondence with each level of the output signal outputted from the speaker. Thereby, the user can easily recognize the difference of the reproduction sound level between the speakers.

In still another example, the display image generating unit may generate the image data so that an image on which an actual arrangement position of the speaker device is reflected is displayed. Thereby, the user can easily make the data in the display image correspond to the actual speaker.

According to another aspect of the present invention, there is provided a computer program which makes a computer function as a sound signal processing apparatus, including: an obtaining unit which obtains a sound signal discriminated for each frequency band; a color assignment unit which assigns color data, different for each frequency band, to the obtained sound signal; a luminance change unit which generates data including a changed luminance of the color data, based on a level for each frequency band of the sound signal; a color mixing unit which generates data obtained by totalizing data generated by the luminance change unit in all the frequency bands; and a display image generating unit which generates image data for display of the data generated by the color mixing unit on the image display device. By executing the computer program on the computer, the user can easily recognize the frequency characteristics of the sound signal, too.

According to still another aspect of the present invention, there is provided a sound signal processing method, including: an obtaining process which obtains a sound signal discriminated for each frequency band; a color assignment process which assigns color data, different for each frequency band, to the obtained sound signal; a luminance change process which generates data including a changed luminance of the color data, based on a level for each frequency band of the sound signal; a color mixing process which generates data obtained by totalizing the data generated in the luminance change process in all the frequency bands; and a display image generating process which generates image data for display on the image display device from data generated in the color mixing process. By executing the sound signal processing method, the user can easily recognize the frequency characteristics of the sound signal, too.

### BRIEF DESCRIPTION OF THE DRAWINGS

FIG. 1 schematically shows a configuration of a sound signal processing system according to an embodiment of the present invention;

FIG. 2 is a block diagram showing a configuration of an audio system including the sound signal processing system according to the embodiment of the present invention;

FIG. 3 is a block diagram showing an internal configuration of a signal processing circuit shown in FIG. 2;

FIG. 4 is a block diagram showing a configuration of a signal processing unit shown in FIG. 3;

FIG. 5 is a block diagram showing a configuration of a coefficient operation unit shown in FIG. 3;

FIGS. 6A to 6C are block diagrams showing configurations of frequency characteristics correction unit, an inter-channel level correction unit and a delay characteristics correction unit shown in FIG. 5;

FIG. 7 is a diagram showing an example of speaker arrangement in a certain sound field environment;

FIG. 8 is a block diagram schematically showing an image processing unit shown in FIG. 1;

FIG. 9 is a diagram schematically showing a concrete example of a process executed in an image processing unit;

FIG. 10 is a diagram for explaining a process executed in a color mixing unit;

FIGS. 11A to 11C are graphs showing a relation between sound signal level/energy and a graphic parameter;

FIG. 12 is a diagram showing an example of an image displayed on a monitor; and

FIG. 13 is a graph showing an example of a test signal.

### BRIEF DESCRIPTION OF THE REFERENCE NUMBER

2 Signal processing circuit
3 Measurement signal generator
8 Microphone
11 Frequency characteristics correction unit
102 Signal processing unit
111 Frequency analyzing filter
200 Sound signal processing apparatus
202 Signal processing unit
203 Measurement signal generator
205 Monitor
207 Frequency analyzing filter
216 Speaker
218 Microphone
230 Image processing unit
231 Color assignment unit
232 Luminance change unit
233 Color mixing unit
234 Luminance/area conversion unit
235 Graphics generating unit

### DETAILED DESCRIPTION OF THE PREFERRED EMBODIMENTS

The preferred embodiment of the present invention will now be described below with reference to the attached drawings.

### [Sound Signal Processing System]

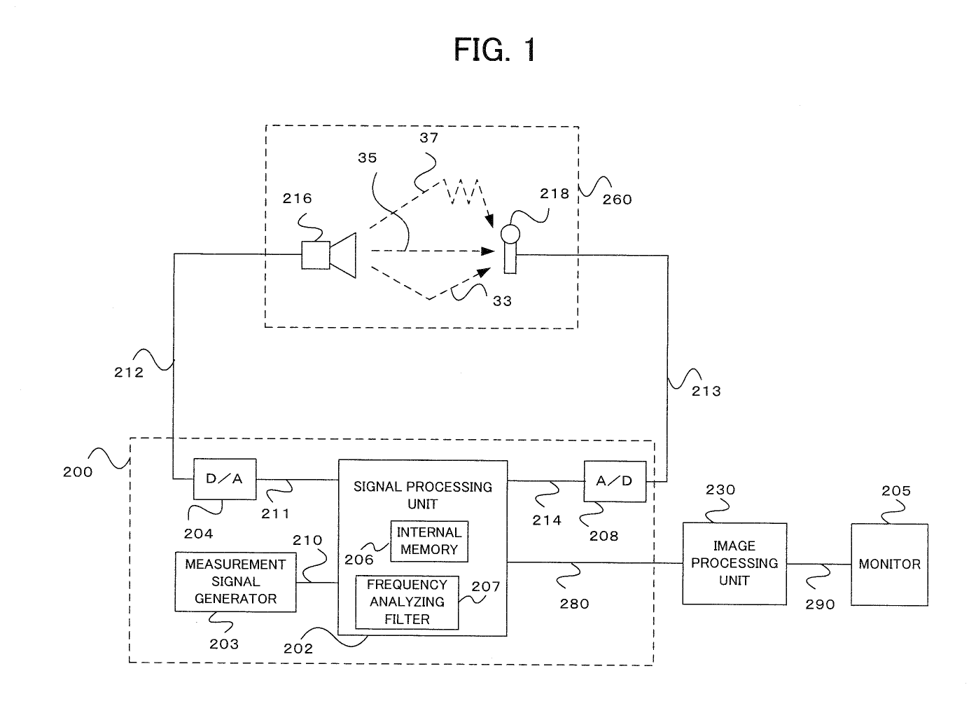

First, a description will be given of a sound signal processing system according to this embodiment. FIG. 1 shows a schematic configuration of the sound signal processing system according to this embodiment. As shown, the sound signal processing system includes a sound signal processing apparatus 200, a speaker 216, a microphone 218, an image processing unit 230 and a monitor 205 connected to the sound signal processing apparatus 200, respectively. The speaker 216 and the microphone 218 are arranged in a sound space 260 subjected to measurement. Typical examples of the sound space 260 are a listening room and a home theater.

The sound signal processing apparatus 200 includes a signal processing unit 202, a measurement signal generator 203, a D/A converter 204 and an A/D converter 208. The signal processing unit 202 includes an internal memory 206 and a frequency analyzing filter 207 inside. The signal processing unit 202 obtains digital measurement sound data 210 from the measurement signal generator 203, and supplies measurement sound data 211 to the D/A converter 204. The D/A converter 204 converts the measurement sound data 211 into an analog measurement signal 212, and supplies it to the speaker 216. The speaker 216 outputs the measurement sound corresponding to the supplied measurement signal 212 to the sound field 260 subjected to the measurement.

The microphone 218 collects the measurement sound outputted to the sound space 260, and supplies a detection signal 213 corresponding to the measurement sound to the A/D converter 208. The A/D converter 208 converts the detection signal 213 into the digital detection sound data 214, and supplies it to the signal processing unit 202.

The measurement sound outputted from the speaker 216 in the sound space 260 is mainly collected by the microphone 218 as a set of a direct sound component 35, an initial reflection sound component 33 and a background sound component 37. The signal processing unit 202 can obtain the sound characteristics of the sound space 260, based on the detection sound data 214 corresponding to the measurement sound collected by the microphone 218. For example, by calculating a sound power for each frequency band, reverberation characteristics for each frequency band of the sound space 260 can be obtained.

The internal memory 206 is a storage unit which temporarily stores the detection sound data 214 obtained via the microphone 218 and the A/D converter 208, and the signal processing unit 202 executes the process such as operation of the sound power with using the detection sound data temporarily stored in the internal memory 206. Thereby, the sound characteristics of the sound space 260 are obtained. The signal processing unit 202 generates the reverberation characteristics of all the frequency bands and the reverberation characteristics for each frequency band with using the frequency analyzing filter 207, and supplies data 280 thus generated to the image processing unit 230.

The image processing unit 230 executes image processing to the data 280 obtained from the signal processing unit 202, and supplies image data 290 after the image processing to the monitor 205. Then, the monitor 205 displays the image data 290 obtained from the image processing unit 230.

### [Configuration of Audio System]

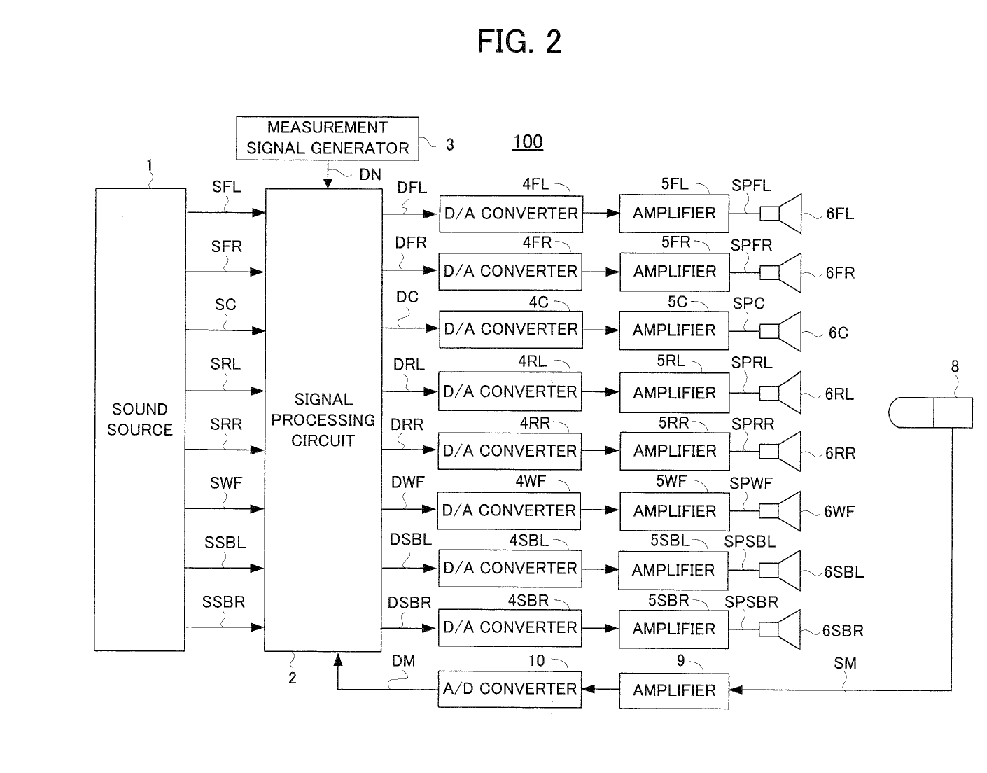

FIG. 2 is a block diagram showing a configuration of an audio system employing the sound signal processing system of the present embodiment.

In FIG. 2, an audio system 100 includes a sound source 1 such as a CD (Compact Disc) player or a DVD (Digital Video Disc or Digital Versatile Disc) player, a signal processing circuit 2 to which the sound source 1 supplies digital audio signals SFL, SFR, SC, SRL, SRR, SWF, SSBL and SSBR via the multi-channel signal transmission paths, and a measurement signal generator 3.

While the audio system 100 includes the multi-channel signal transmission paths, the respective channels are referred to as “FL-channel”, “FR-channel” and the like in the following description. In addition, the subscripts of the reference number are omitted to refer to all of the multiple channels when the signals or components are expressed. On the other hand, the subscript is put to the reference number when a particular channel or component is referred to. For example, the description “digital audio signals S” means the digital audio signals SFL to SSBR, and the description “digital audio signal SFL” means the digital audio signal of only the FL-channel.

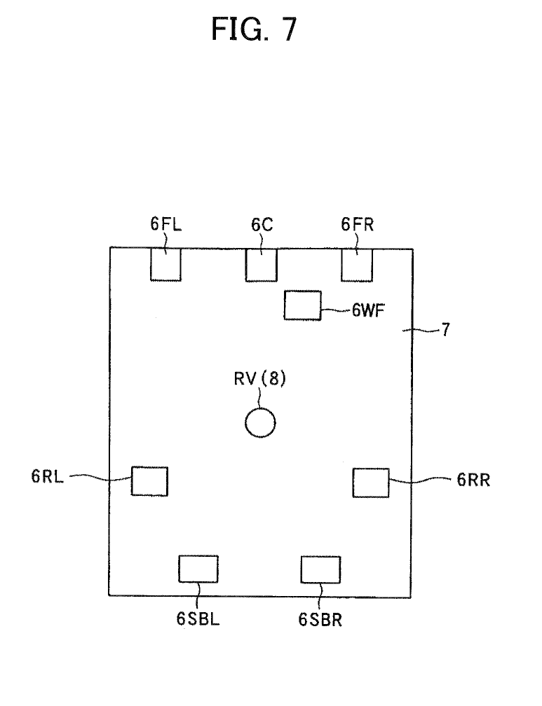

Further, the audio system 100 includes D/A converters 4FL to 4SBR for converting the digital output signals DFL to DSBR of the respective channels processed by the signal processing by the signal processing circuit 2 into analog signals, and amplifiers 5FL to 5SBR for amplifying the respective analog audio signals outputted by the D/A converters 4FL to 4SBR. In this system, the analog audio signals SPFL to SPSBR after the amplification by the amplifiers 5FL to 5SBR are supplied to the multi-channel speakers 6FL to 6SBR positioned in a listening room 7, shown in FIG. 7 as an example, to output sounds.

The audio system 100 also includes a microphone 8 for collecting reproduced sounds at a listening position RV, an amplifier 9 for amplifying a collected sound signal SM outputted from the microphone 8, and an A/D converter 10 for converting the output of the amplifier 9 into a digital collected sound data DM to supply it to the signal processing circuit 2.

The audio system 100 activates full-band type speakers 6FL, 6FR, 6C, 6RL, 6RR having frequency characteristics capable of reproducing sound for substantially all audible frequency bands, a speaker 6WF having frequency characteristics capable of reproducing only low-frequency sounds and surround speakers 6SBL and 6SBR positioned behind the listener (user), thereby creating sound field with presence around the listener at the listening position RV.

With respect to the positions of the speakers, as shown in FIG. 7, for example, the listener places the two-channel, left and right speakers (a front-left speaker and a front-right speaker) 6FL, 6FR and a center speaker 6C, in front of the listening position RV, in accordance with the listener's taste. Also the listener places the two-channel, left and right speakers (a rear-left speaker and a rear-right speaker) 6RL, 6RR as well as two-channel, left and right surround speakers 6SBL, 6SBR behind the listening position RV, and further places the sub-woofer 6WF exclusively used for the reproduction of low-frequency sound at any position. The audio system 100 supplies the analog audio signals SPFL to SPSBR, for which the frequency characteristic, the signal level and the signal propagation delay characteristics for each channel are corrected, to those 8 speakers 6FL to 6SBR to output sounds, thereby creating sound field space with presence.

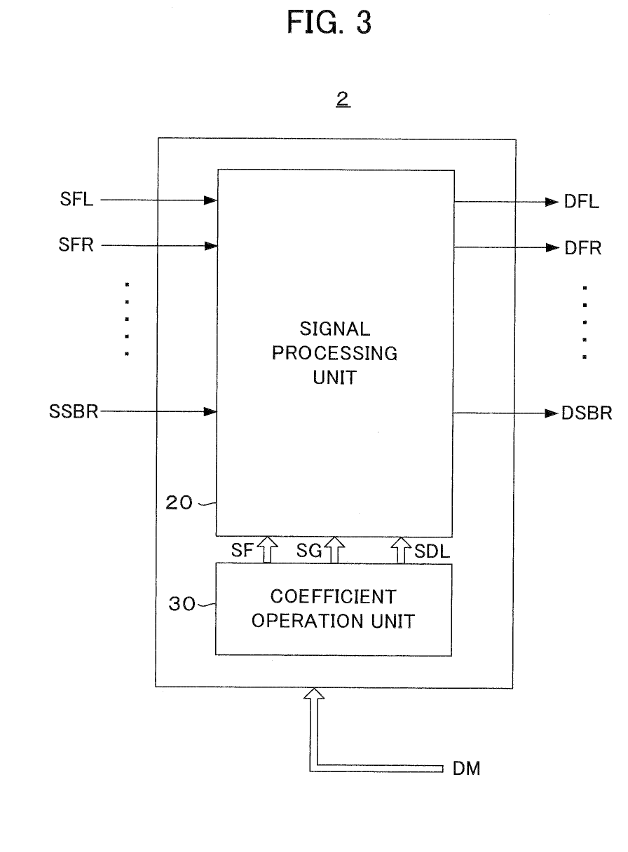

The signal processing circuit 2 may have a digital signal processor (DSP), and roughly includes a signal processing unit 20 and a coefficient operation unit 30 as shown in FIG. 3. The signal processing unit 20 receives the multi-channel digital audio signals from the sound source 1 reproducing sound from various sound sources such as a CD, a DVD or else, and performs the frequency characteristics correction, the level correction and the delay characteristics correction for each channel to output the digital output signals DFL to DSBR.

The coefficient operation unit 30 receives the signal collected by the microphone 8 as the digital collected sound data DM and a measurement signal DMI outputted from the delay circuit DLY1 to DLY8 in the signal processing unit 2. Then, the coefficient operation unit 30 generates the coefficient signals SF1 to SF8, SG1 to SG8, SDL1 to SDL8 for the frequency characteristics correction, the level correction and the delay characteristics correction, and supplies them to the signal processing unit 20. The signal processing unit 20 performs the frequency characteristics correction, the level correction and the delay characteristics correction, and the speakers 6 output optimum sounds.

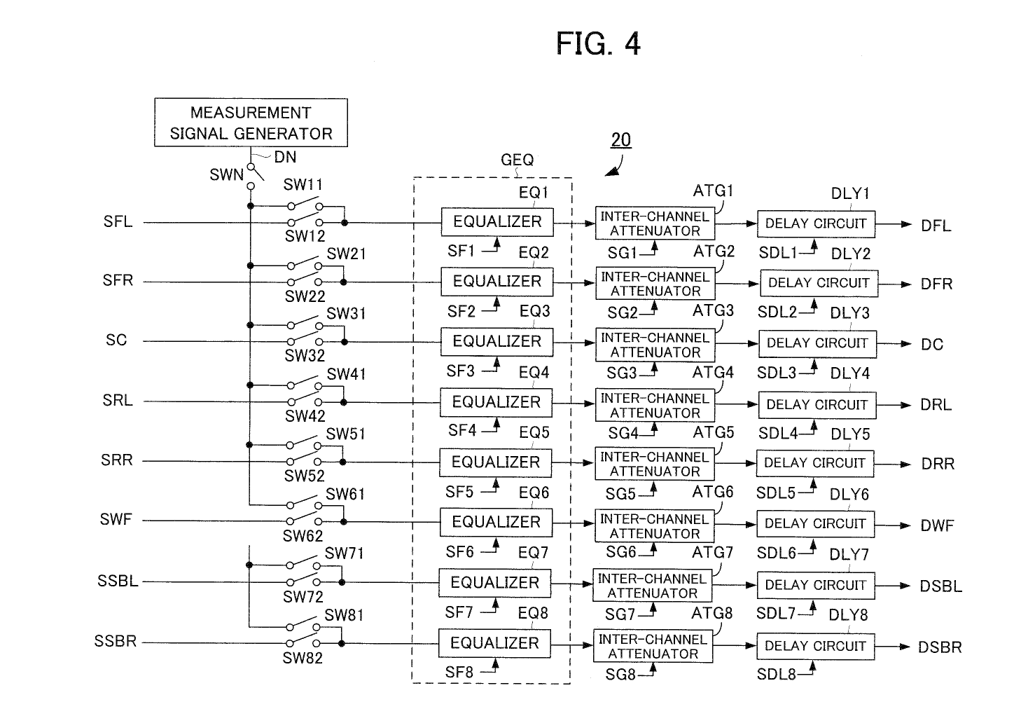

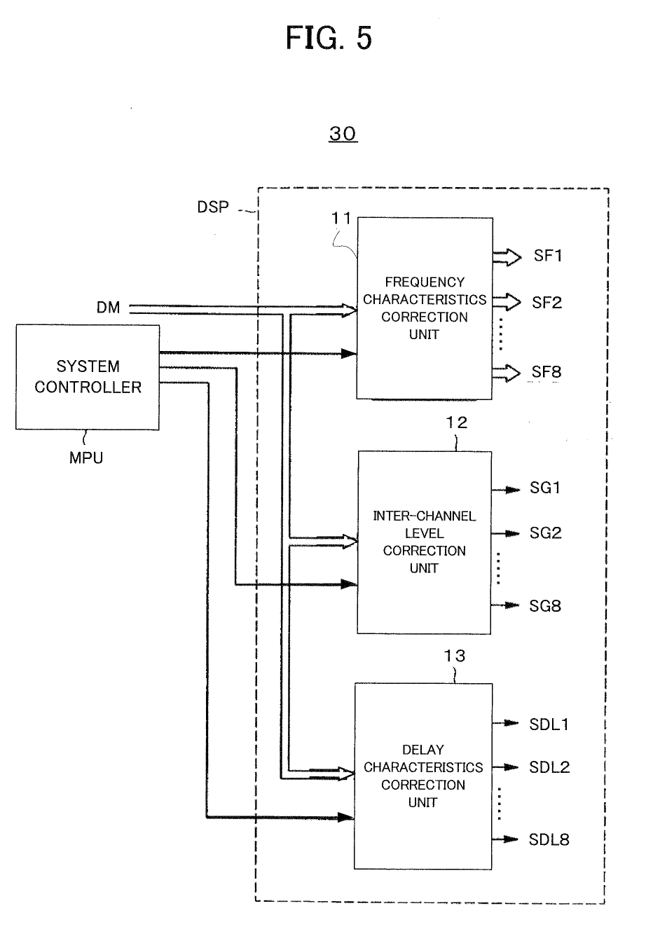

As shown in FIG. 4, the signal processing unit 20 includes a graphic equalizer GEQ, inter-channel attenuators ATG1 to ATG8, and delay circuits DLY1 to DLY8. On the other hand, the coefficient operation unit 30 includes, as shown in FIG. 5, a system controller MPU, frequency characteristics correction unit 11, an inter-channel level correction unit 12 and a delay characteristics correction unit 13. The frequency characteristics correction unit 11, the inter-channel level correction unit 12 and the delay characteristics correction unit 13 constitute DSP.

The frequency characteristics correction unit 11 sets the coefficients (parameters) of equalizers EQ1 to EQ8 corresponding to the respective channels of the graphic equalizer GEQ, and adjusts the frequency characteristics thereof. The inter-channel level correction unit 12 controls the attenuation factors of the inter-channel attenuators ATG1 to ATG8, and the delay characteristics correction unit 13 controls the delay times of the delay circuits DLY1 to DLY8. Thus, the sound field is appropriately corrected.

The equalizers EQ1 to EQ5, EQ7 and EQ8 of the respective channels are configured to perform the frequency characteristics correction for each frequency band. Namely, the audio frequency band is divided into 8 frequency bands (each of the center frequencies are F1 to F8), for example, and the coefficient of the equalizer EQ is determined for each frequency band to correct frequency characteristics. It is noted that the equalizer EQ6 is configured to control the frequency characteristics of low-frequency band.

With reference to FIG. 4, the switch element SW12 for switching ON and OFF the input digital audio signal SFL from the sound source 1 and the switch element SW11 for switching ON and OFF the input measurement signal DN from the measurement signal generator 3 are connected to the equalizer EQ1 of the FL-channel, and the switch element SW11 is connected to the measurement signal generator 3 via the switch element SWN.

The switch elements SW11, SW12 and SWN are controlled by the system controller MPU configured by microprocessor shown in FIG. 5. When the sound source signal is reproduced, the switch element SW12 is turned ON, and the switch elements SW11 and SWN are turned OFF. On the other hand, when the sound field is corrected, the switch element SW12 is turned OFF and the switch elements SW11 and SWN are turned ON.

The inter-channel attenuator ATG1 is connected to the output terminal of the equalizer EQ1, and the delay circuit DLY1 is connected to the output terminal of the inter-channel attenuator ATG1. The output DFL of the delay circuit DLY1 is supplied to the D/A converter 4FL shown in FIG. 2.

The other channels are configured in the same manner, and switch elements SW21 to SW81 corresponding to the switch element SW11 and the switch elements SW22 to SW82 corresponding to the switch element SW12 are provided. In addition, the equalizers EQ2 to EQ8, the inter-channel attenuators ATG2 to ATG8 and the delay circuits DLY2 to DLY8 are provided, and the outputs DFR to DSBR from the delay circuits DLY2 to DLY8 are supplied to the D/A converters 4FR to 4SBR, respectively, shown in FIG. 2.

Further, the inter-channel attenuators ATG1 to ATG8 vary the attenuation factors within the range equal to or smaller than 0 dB in accordance with the adjustment signals SG1 to SG8 supplied from the inter-channel level correction unit 12. The delay circuits DLY1 to DLY8 control the delay times of the input signal in accordance with the adjustment signals SDL1 to SDL8 from the phase characteristics correction unit 13.

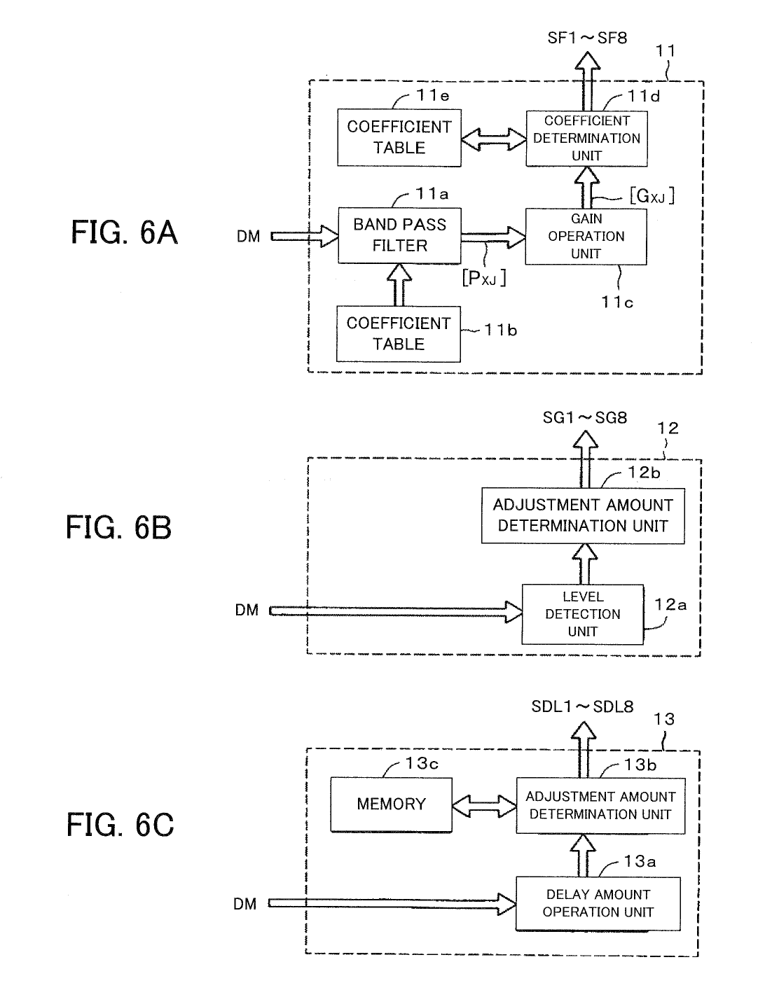

The frequency characteristics correction unit 11 has a function to adjust the frequency characteristics of each channel to have a desired characteristic. As shown in FIG. 5, the frequency characteristics correction unit 11 analyzes the frequency characteristics of the collected sound data DM supplied from the A/D converter 10, and determines the coefficient adjustment signals SF1 to SF8 of the equalizers EQ1 to EQ8 so that the frequency characteristics become the target frequency characteristics. As shown in FIG. 6A, the frequency characteristics correction unit 11 includes a band-pass filter 11a serving as a frequency analyzing filter, a coefficient table 11b, a gain operation unit 11c, a coefficient determination unit lid and a coefficient table 11e.

The band-pass filter 11a is configured by a plurality of narrow-band digital filters passing 8 frequency bands set to the equalizers EQ1 to EQ8. The band-pass filter 11a discriminates 8 frequency bands including center frequencies F1 to F8 from the collected sound data DM from the A/D converter 10, and supplies the data [PxJ] indicating the level of each frequency band to the gain operation unit 11c. The frequency discriminating characteristics of the band-pass filter 11a is determined based on the filter coefficient data stored, in advance, in the coefficient table 11b.

The gain operation unit 11c operates the gains of the equalizers EQ1 to EQ8 for the respective frequency bands at the time of the sound field correction based on the data [PxJ] indicating the level of each frequency band, and supplies the gain data [GxJ] thus operated to the coefficient determination unit 11d. Namely, the gain operation unit 11c applies the data [PxJ] to the transfer functions of the equalizers EQ1 to EQ8 known in advance to calculate the gains of the equalizers EQ1 to EQ8 for the respective frequency bands in the reverse manner.

The coefficient determination unit 11d generates the filter coefficient adjustment signals SF1 to SF8, used to adjust the frequency characteristics of the equalizers EQ1 to EQ8, under the control of the system controller MPU shown in FIG. 5. It is noted that the coefficient determination unit 11d is configured to generate the filter coefficient adjustment signals SF1 to SF8 in accordance with the conditions instructed by the listener, at the time of the sound field correction. In a case where the listener does not instruct the sound field correction condition and the normal sound field correction condition preset in the sound field correcting system is used, the coefficient determination unit lid reads out the filter coefficient data, used to adjust the frequency characteristics of the equalizers EQ1 to EQ8, from the coefficient table 11e by using the gain data [GxJ] for the respective frequency bands supplied from the gain operation unit 11c, and adjusts the frequency characteristics of the equalizers EQ1 to EQ8 based on the filter coefficient adjustment signals SF1 to SF8 of the filter coefficient data.

In other words, the coefficient table 11e stores the filter coefficient data for adjusting the frequency characteristics of the equalizers EQ1 to EQ8, in advance, in a form of a look-up table. The coefficient determination unit lid reads out the filter coefficient data corresponding to the gain data [GxJ], and supplies the filter coefficient data thus read out to the respective equalizers EQ1 to EQ8 as the filter coefficient adjustment signals SF1 to SF8. Thus, the frequency characteristics are controlled for the respective channels.

Next, the description will be given of the inter-channel level correction unit 12. The inter-channel level correction unit 12 has a role to adjust the sound pressure levels of the sound signals of the respective channels to be equal. Specifically, the inter-channel level correction unit 12 receives the collected sound data DM obtained when the respective speakers 6FL to 6SBR are individually activated by the measurement signal (pink noise) DN outputted from the measurement signal generator 3, and measures the levels of the reproduced sounds from the respective speakers at the listening position RV based on the collected sound data DM.

FIG. 6B schematically shows the configuration of the inter-channel level correction unit 12. The collected sound data DM outputted by the A/D converter 10 is supplied to a level detection unit 12a. It is noted that the inter-channel level correction unit 12 uniformly attenuates the signal levels of the respective channels for all frequency bands, and hence the frequency band division is not necessary. Therefore, the inter-channel level correction unit 12 does not include any band-pass filter as shown in the frequency characteristics correction unit 11 in FIG. 6A.

The level detection unit 12a detects the level of the collected sound data DM, and carries out gain control so that the output audio signal levels for all channels become equal to each other. Specifically, the level detection unit 12a generates the level adjustment amount indicating the difference between the level of the collected sound data thus detected and a reference level, and supplies it to an adjustment amount determination unit 12b. The adjustment amount determination unit 12b generates the gain adjustment signals SG1 to SG8 corresponding to the level adjustment amount received from the level detection unit 12a, and supplies the gain adjustment signals SG1 to SG8 to the respective inter-channel attenuators ATG1 to ATG8. The inter-channel attenuators ATG1 to ATG8 adjust the attenuation factors of the audio signals of the respective channels in accordance with the gain adjustment signals SG1 to SG8. By adjusting the attenuation factors of the inter-channel level correction unit 12, the level adjustment (gain adjustment) for the respective channels is performed so that the output audio signal level of the respective channels become equal to each other.

The delay characteristics correction unit 13 adjusts the signal delay resulting from the difference in distance between the positions of the respective speakers and the listening position RV. Namely, the delay characteristics correction unit 13 has a role to prevent that the output signals from the speakers 6 to be listened simultaneously by the listener reach the listening position RV at different times. Therefore, the delay characteristics correction unit 13 measures the delay characteristics of the respective channels based on the collected sound data DM which is obtained when the speakers 6 are individually activated by the measurement signal (pink noise) DN outputted from the measurement signal generator 3, and corrects the phase characteristics of the sound field space based on the measurement result.

Specifically, by turning over the switches SW11 to SW82 shown in FIG. 4 one after another, the measurement signal DN generated by the measurement signal generator 3 is output from the speakers 6 for each channel, and the output sound is collected by the microphone 8 to generate the correspondent collected sound data DM. Assuming that the measurement signal is a pulse signal such as an impulse, the difference between the time when the speaker 6 outputs the pulse measurement signal and the time when the microphone 8 receives the correspondent pulse signal is proportional to the distance between the speaker 6 of each channel and the listening position RV. Therefore, the difference in distance of the speakers 6 of the respective channels and the listening position RV may be absorbed by setting the delay time of all channels to the delay time of the channel having largest delay time. Thus, the delay time between the signals generated by the speakers 6 of the respective channels become equal to each other, and the sound outputted from the multiple speakers 6 and coincident with each other on the time axis simultaneously reach the listening position RV.

FIG. 6C shows the configuration of the delay characteristics correction unit 13. A delay amount operation unit 13a receives the collected sound data DM, and operates the signal delay amount resulting from the sound field environment for the respective channels on the basis of the pulse delay amount between the pulse measurement signal and the collected sound data DM. A delay amount determination unit 13b receives the signal delay amounts for the respective channels from the delay amount operation unit 13a, and temporarily stores them in a memory 13c. When the signal delay amounts for all channels are operated and temporarily stored in the memory 13c, the delay amount determination unit 13b determines the adjustment amounts of the respective channels such that the reproduced signal of the channel having the largest signal delay amount reaches the listening position RV simultaneously with the reproduced sounds of other channels, and supplies the adjustment signals SDL1 to SDL8 to the delay circuits DLY1 to DLY8 of the respective channels. The delay circuits DLY1 to DLY8 adjust the delay amount in accordance with the adjustment signals SDL1 to SDL8, respectively. Thus, the delay characteristics for the respective channels are adjusted. It is noted that, while the above example assumed that the measurement signal for adjusting the delay time is the pulse signal, this invention is not limited to this, and other measurement signal may be used.

### [Image Processing Method]

Next, a description will be given of image processing which is executed in an image processing unit 230 in a sound signal processing apparatus 200 according to an embodiment.

### (Configuration of Image Processing Unit)

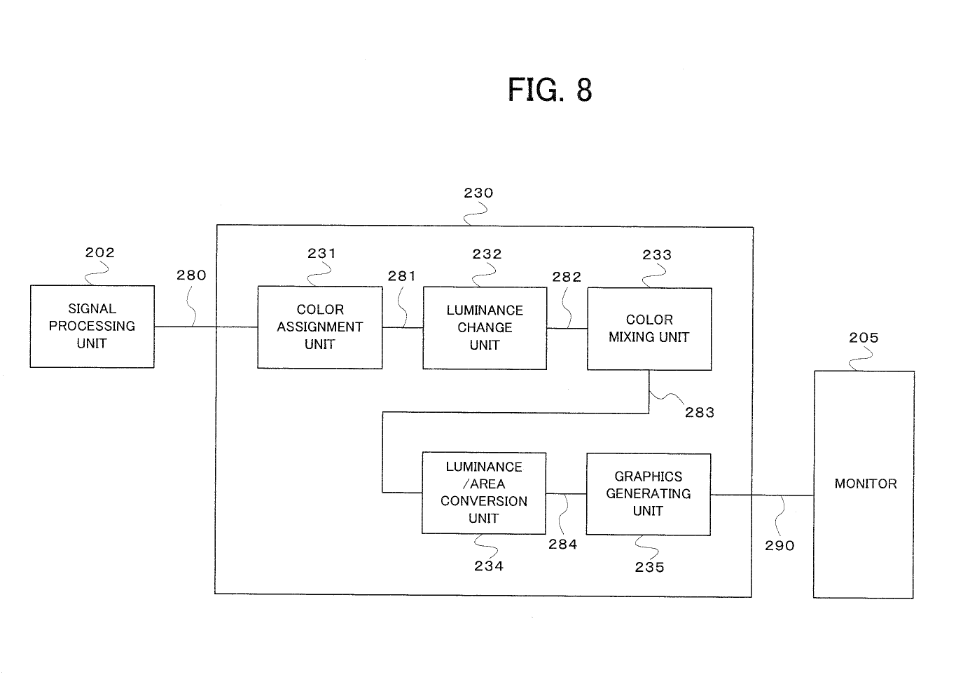

First, an entire configuration of the image processing unit 230 will be explained with reference to FIG. 8.

FIG. 8 is a block diagram schematically showing a configuration of the image processing unit 230. The image processing unit 230 includes a color assignment unit 231, a luminance change unit 232, a color mixing unit 233, a luminance/area conversion unit 234 and a graphics generating unit 235.

The color assignment unit 231 obtains, from the signal processing unit 202, the data 280 including the sound signal discriminated for each frequency band. Concretely, the data [PxJ], showing the level of each frequency band obtained by discriminating the collected sound data DM for each frequency band by the band pass filter 11a of the above-mentioned frequency correction unit 11, is inputted to the color assignment unit 231. For example, the data discriminated into six frequency bands including the frequency F1 to F6 is inputted to the color assignment unit 231.

The color assignment unit 231 assigns color data different for each of the data in the inputted frequency band. Specifically, the color assignment unit 231 assigns the RGB-type data showing a predetermined color to each data in the frequency band. Then, the color assignment unit 231 supplies the RGB-type image data 281 to the luminance change unit 232.

The luminance change unit 232 generates the image data 282 including the changed luminance of the obtained RGB-type image data 282 in correspondence with the level (the sound energy or the sound pressure level) of the sound signal for each frequency band. Then, the luminance change unit 232 supplies the generated image data 282 to the color mixing unit 233.

The color mixing unit 233 executes the process of totalizing of the RGB components in the obtained image data 282. Specifically, the color mixing unit 233 executes the process of totalizing of the R component data, the G component data and the B component data in all the frequency bands. Subsequently, the color mixing unit 233 supplies the totalized image data 283 to the luminance/area conversion unit 234.

The normalized R component data, the normalized G component data and the normalized B component data are inputted to the color mixing unit 233. Thus, when the R component data, the G component data and the B component data are equal to each other, “R component data: G component data: B component data=1:1:1”. In the image processing unit 230 according to this embodiment, the image data including “R component data: G component data: B component data=1:1:1” is displayed with white.

On the other hand, the image data 283 generated in the color mixing unit 233 is inputted to the luminance/area conversion unit 234. In this case, the luminance/area conversion unit 234 executes the process, in consideration of the entire image data 283 obtained from the plural channels. Concretely, the luminance/area conversion unit 234 changes the luminance of the plural inputted image data 283 in accordance with the levels of the sound signals of the plural channels, and executes the process of assigning the area (including measure) of the displayed image. Namely, the luminance/area conversion unit 234 converts the image data 283 of each channel, based on the characteristics of all the channels. Then, the luminance/area conversion unit 234 supplies the generated image data 284 to the graphics generating unit 235.

The graphics generating unit 235 obtains the image data 284 including the information of the image luminance and area, and generates graphics data 290 which the monitor 205 can display. The monitor 205 displays the graphics data 290 obtained from the graphics generating unit 235.

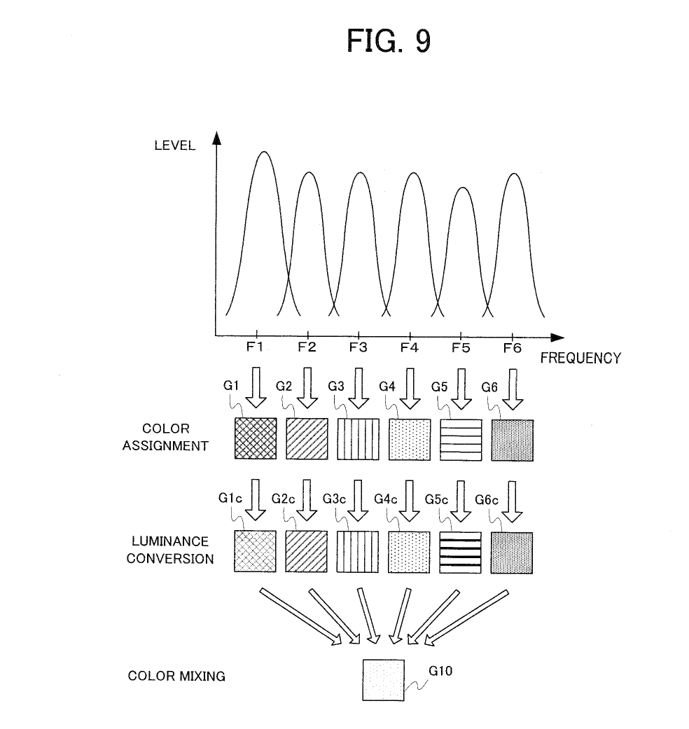

The process executed in the image processing unit 230 will be concretely explained with reference to FIG. 9. FIG. 9 schematically shows the process in the color assignment unit 231, the process in the luminance change unit 232 and the process in the color mixing unit 233.

A frequency spectrum of the sound signal is shown at the upper part in FIG. 9. The horizontal axis thereof shows the frequency, and the vertical axis thereof shows the level of the sound signal. The frequency spectrum shows the level of the sound signal for one channel discriminated into the six frequency bands including the center frequencies F1 to F6.

The color assignment unit 231 of the image processing unit 230 assigns image data G1 to G6 to the data discriminated into the six frequency bands. The hatching differences in the image data G1 to G6 show the color differences. The image data G1 to G6 are formed by the RGB components. The color assignment unit 231 can assign the color by associating high/low (long/short of wavelength) of the frequency of the sound signal with the color variation (long/short of light wavelength) based on the sound wavelength and the light wavelength so that the user can easily understand the display image. Specifically, the image data G1, G2, G3, G4, G5 and G6 can be set to “red”, “orange”, “yellow”, “green”, “blue” and “navy blue”, respectively (high/low of the frequency and the color variation may be conversely set, too). The luminance of the image data G1 to G6 is numerically same. Additionally, the color assignment unit 231 sets the image data G1 to G6 assigned to each frequency band so that the data, obtained by totally adding the R component, the G component and the B component in the RGB type data of the image data G1 to G6, becomes the data showing “white”. The reason will be described later.

The luminance change unit 232 changes the luminance in accordance with the level of each frequency band, and generates image data G1c to G6c in correspondence to the image data G1 to G6 to which the colors are assigned in this manner. Thereby, the luminance of the image data G1 becomes large, and the luminance of the image data G5 becomes small, for example. The color mixing unit 233 totalizes the entire data of each RGB component of the image data G1c to G6c, and generates the image data G10.

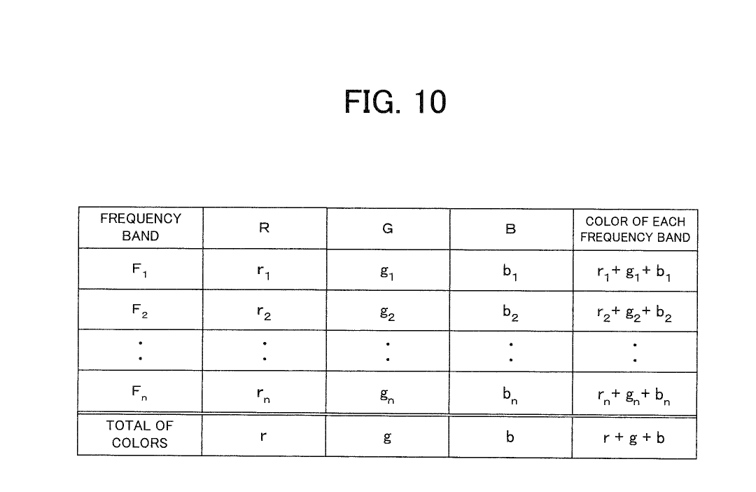

Now, the concrete example of the process of totalizing of the RGB component data, executed in the color mixing unit 233, will be explained with reference to FIG. 10. FIG. 10 shows the data including the luminance changed in the luminance/change unit 232 and the data obtained by the totaling in the color mixing unit 233, in such a case that the sound signal is discriminated into the n frequency bands including the center frequencies F1 to Fn. FIG. 10 shows the data of the sound signal for one channel.

As for the data including the luminance changed in the luminance/change unit 232, the R component is “r₁”, the G component is “g₁” and the B component is “b₁” in the data of the frequency band (hereinafter, the frequency band including the center frequency Fx is referred to as “frequency band Fx(1≦x≦n)”) including the center frequency F1. Similarly, the R component is “r₂”, the G component is “g₂” and the B component is “b₂” in the data of the frequency band F2, and the R component is “rₙ”, the G component is “gₙ”, and the B component is “bₙ” in the data of the frequency band Fn. In this case, the color of the image data showing each frequency band is shown by the value obtained by totalizing each data of the RGB components. Namely, the value is “r₁+g₁+b₁” in the frequency band F1, and the value is “r₂+g₂+b₂” in the frequency band F2. Similarly, the value is “rₙ+gₙ+bₙ” in the frequency band Fn.

The process of totalizing of the data, generated in the luminance change unit 232, in the color mixing unit 233 is executed. The R component data becomes “r=r₁+r₂+ . . . +rₙ”, and the G component data becomes “g=g₁+g₂+ . . . +gₙ”. The B component data becomes “b=b₁+b₂+ . . . +bₙ”. Therefore, the frequency characteristics of the channel subjected to the processing is expressed by “r+g+b” obtained by totalizing the data. Namely, the frequency characteristics of the channel can be recognized by the color of the image corresponding to the data “r+g+b”. As “r”, “g” and “b” obtained by totalizing of the R component data, the G component data and the B component data, the values normalized by the pre-set maximum value are used. The image luminance obtained in this stage is normalized for each channel, in order to be numerously equal between channels.

After the above processing, at least one of the luminance, the area (graphic area) and the measure of the image obtained by the total, is changed in correspondence with the level difference between the plural channels in the luminance/area conversion unit 234. Thereby, the displayed image color shows the frequency characteristics for each channel, and the displayed image luminance, area and measure show the level for each channel. In such a case that the normalization is executed in all the channels without the normalization after the processing of the total in the color mixing unit 233, the level for each channel shows the luminance.

By totalizing the data for each frequency band in the above manner, the color state of the data obtained by the total shows the frequency characteristics. Therefore, the user can viscerally recognize the frequency characteristics. For example, in such a case that the color of the low frequency band is set to a red-type color and the color of the high frequency band is set to a blue-type color, it is understood that the level of the low frequency is large if the color of the image obtained in the color mixing unit 233 is reddish. Meanwhile, it is understood that the level of the high frequency is large if the color is bluish. Namely, because of displaying one pixel generated by mixing the data for each frequency band, the sound signal processing apparatus 200 according to this embodiment can express the frequency characteristics for one channel with the much smaller image. Thereby, the user can easily understand the frequency characteristics of the sound signal outputted from the speaker. Thus, the measurement of the sound field characteristics and the burden of the user at the time of adjustment can be reduced.

Additionally, the color data is set so that the data obtained by totalizing the entire color data assigned in the color assignment unit 231 becomes the data showing “white”. Therefore, when the R component data “r”, the G component data “g” and the B component data “b”, finally obtained in the color mixing unit 233, are equal to each other, i.e., when “r:g:b=1:1:1”, the color of the data obtained by totalizing all the components also becomes white. In this case, when “r”, “g” and “b” are equal to each other, the level of each frequency band is substantially same. Namely, the frequency characteristics are flat. Hence, the user can easily recognize that the frequency characteristics of the sound signals are flat.

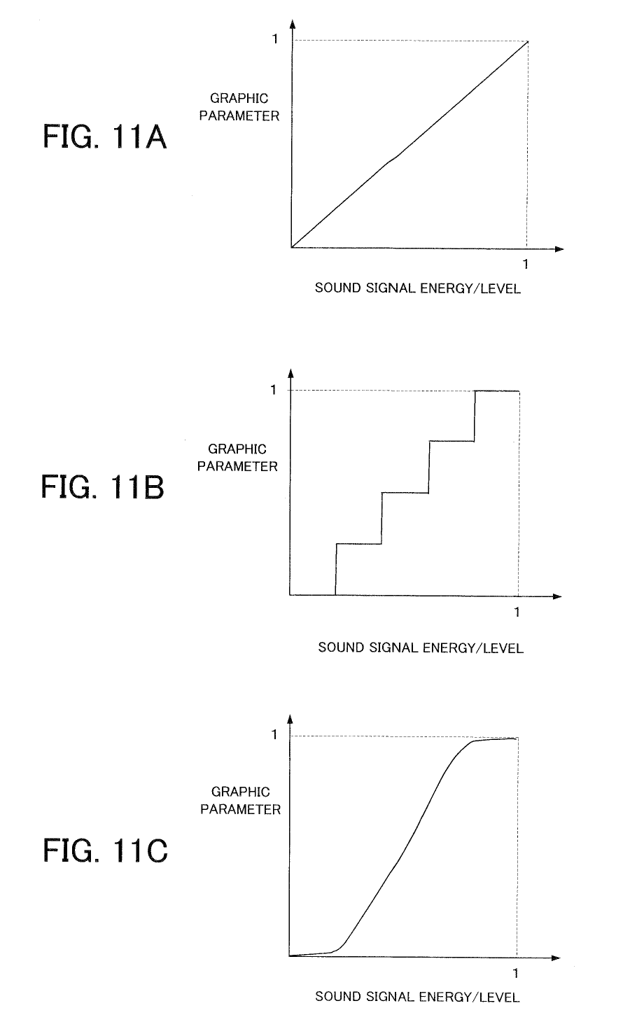

Now, a description will be given of a concrete example of the process of changing the image luminance, measure and area (hereinafter, totally referred to as “graphic parameter”, too) in correspondence with the level/energy of the sound signal, which is executed in the luminance change unit 232 and the luminance/area conversion unit 234, with reference to FIGS. 11A to 11C.

In FIGS. 11A to 11C, the horizontal axis shows the level/energy of the measured sound signal, and the vertical axis shows the graphic parameter converted in correspondence with the level/energy of the sound signal. When the value of the horizontal axis shown in FIGS. 11A to 11C is set on the basis of the energy of the sound signal, the energy of the signal (hereinafter referred to as “test signal”) which the measurement signal generator 203 generates at the time of the measurement or the largest energy obtained by the measurement is defined as “1”, and thereby the normalized value is used. Meanwhile, when the value is set based on the sound pressure level, the value obtained by setting an optional level which a system designer or the user determines as the reference level, or the value obtained by setting the test signal or the largest measurement value as the reference level is used.

FIG. 11A shows a first example of the process of converting the level/energy of the sound signal into the graphic parameter. In this case, the process of the conversion is executed so that the graphic parameter satisfies the relation of the linear expression to the level/energy of the measured sound signal.

FIG. 11B shows a second example of the process of the conversion to the graphic parameter. In this case, the process of the conversion is executed with using the function making the level/energy of the sound signal gradually correspond to the graphic parameter. In this case, since a dead zone is provided in the graphic parameter, the variation of the graphic parameter becomes insensitive to the variation of the level/energy of the sound signal.

FIG. 11C shows a third example of the process of the conversion into the graphic parameter. In this case, the process of the conversion is executed with using the function expressed by an S-shaped curve. In this case, the degree of the variation of the graphic parameter can be gently curved in the vicinity of the minimum value and the maximum value of the level/energy of the sound signal.

As shown in the above second and third examples, the process of the conversion to the graphic parameter with using the simple liner function is not executed. Now, the explanation will be given. Since the human is sensitive to the color irregularity (relative color difference), the variation of the micro level can be recognized as the large variation if the sensitive luminance variation to the level variation is given. Namely, the luminance change unit 232 and the luminance/area conversion unit 234 can change the luminance of the image data generated in consideration of the human visual characteristics.

Instead of the process of the conversion into the graphic parameter on the basis of the relations shown in FIGS. 11A to 11C, such conversion that the sound signal lower than the reference level by the predetermined value becomes the minimum value (e.g., luminance “0”) of the graphic parameter may be executed based on the sound pressure level of the measured sound signal. In this case, as concrete values used for the predetermined value, there can be used three values: an optional value (the user may adjust the value as he or she likes) determined by the designer or the user; the level of “−60 dB” (the value obtained by converting this level into the energy may be used) being the general reference at the time of calculating the reverberation time; or the level of the background noise in the measured listening room (the information equal to or smaller than the background noise cannot be measured, and there is no opportunity to display the data equal to or smaller than the background noise).

### (Concrete Example of Display Image)

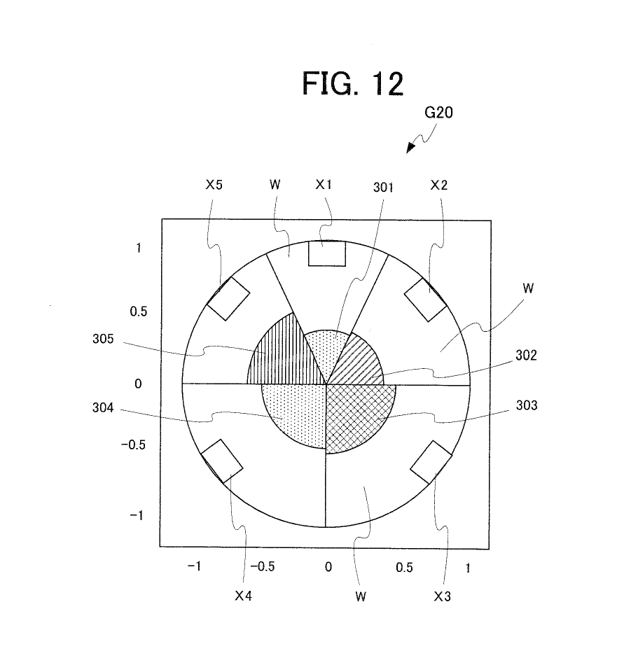

Next, a description will be given of the image displayed on the monitor 205 after the above-mentioned image process, with reference to FIG. 12.

FIG. 12 shows a concrete example of the image displayed on the monitor 205. FIG. 12 shows an image G20 on which all the data corresponding to the measurement results of the sound signals (i.e., 5 channels) outputted from five speakers X1 to X5 are simultaneously displayed. In this case, the position of the image G20 on which the speakers X1 to X5 are displayed substantially corresponds to the arrangement positions of the speakers X1 to X5 in the listening room in which the measurement is executed. In addition, the images showing the measurement results corresponding to the speakers X1 to X5 are shown by images 301 to 305 having fan shapes. Concretely, the colors of the images 301 to 305 show the respective frequency characteristics of the speakers X1 to X5, and radiuses of the fan shapes of the images 301 to 305 relatively show the sound levels in the speakers X1 to X5.

Additionally, in the image G20, areas W around the fan-shaped images 301 to 305 are displayed with white. This is for easy realizing of the comparison between the colors of the images 301 to 305 showing the frequency characteristics of the speakers X1 to X5 and the color (white) in such a case that the frequency characteristics are flat.

The display of the image G20 enables the user to immediately specify the speaker having the biased frequency characteristics by seeing the colors of the fan shapes 301 to 305, and also enables the user to easily compare the sound levels of the speakers X1 to X5 by seeing the radiuses of the fan shapes 301 to 305. Further, since the positions of the image G20 on which the speakers X1 to X5 are displayed substantially correspond to the actual arrangement positions of the speakers X1 to X5, the user can easily compare the speakers X1 to X5.

As described above, in the sound signal processing apparatus 200 according to this embodiment, even if all of the measurement results of five channels are displayed on the single image, the entire image for each channel frequency band is not displayed, and the image including the mixed data for each frequency band is displayed for each channel. Thereby, since the displayed image becomes convenient, the burden of the user at the time of understanding of the image can be reduced.

The sound signal processing apparatus 200 according to this embodiment can display the image including the mixed data of all the channels (i.e., the totalized RGB component data in all the channels), instead of dividing and displaying the data showing the characteristics of each channel. In this case, the user can immediately recognize the states of all the channels.

Now, a description will be given of a test signal used for animation display (display of the image showing such a state that the characteristics of the sound signal change with time) of the image shown in FIG. 12. When the animation display of the image shown in FIG. 12 is performed, no fan shape of each channel is first displayed, and the fan shape of each channel gradually becomes large. When the signal is not inputted after the steady state, the fan shape is gradually becoming small. Such a state is displayed. The data of the rise-up, steady state and fall-down of each channel becomes necessary in order to perform such animation display. The test signal is used in order to obtain the data.

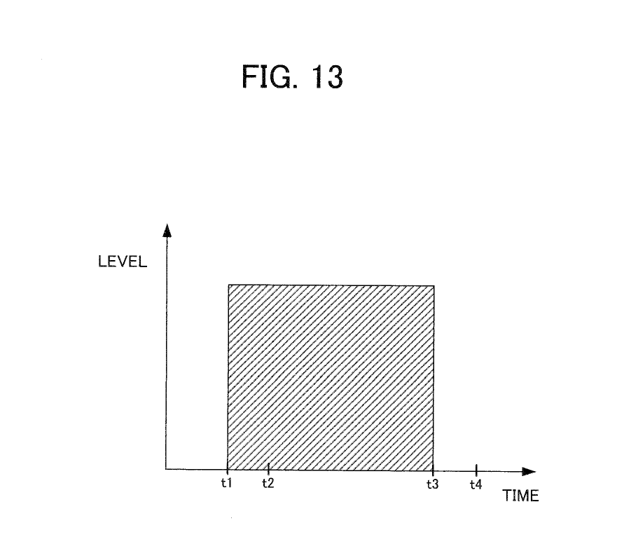

FIG. 13 is a diagram showing an example of the test signal. In FIG. 13, the horizontal axis shows time, and the vertical axis shows the level of the sound signal, which show the test signal outputted from the measurement signal generator 203. The test signal is generated from time t1 to time t3, and is formed by the noise signal. The measurement data is obtained by recording the time variation of the output of each band bass filter 207. Specifically, the rise-up time, the frequency characteristics at the time of the rise-up, the frequency characteristics in the steady state, the fall-down time and the frequency characteristics at the time of the fall-down are analyzed. The rise-up state, the steady state and the fall-down state are determined by the variation ratio of the output of each band pass filter 207. For example, such a case that the measurement data rises by 3 dB with respect to no reproduction of the test signal is determined as the rise-up state. Meanwhile, such a case that the variation of the measurement data is within the range of ±3 dB is determined as the steady state. It is necessary to change the threshold used for the determination in accordance with the background noise, the state of the listening room and the frame time of the analysis. It is not limited that the data necessary for the animation display is obtained with using the test signal. For example, the data may be obtained by analysis on the basis of the impulse response of the system and the transfer function of the system.

In another example, the sound signal processing apparatus 200 can display the image of the animation display extended in the time direction, too. For example, in the sound signal measured in the speaker, the image can be displayed in a fast forward state when the sound signal is in the steady state, and the image can be displayed in a slow state when precipitous change such as the rise-up and fall-down of the sound signal occurs. In this manner, by executing the fast forward display and the slow display, it becomes easy for the user to recognize the change of the sound signal.

The sound signal processing apparatus 200 can also perform the animation display of the test signal shown in FIG. 13. Thereby, the user can simultaneously see the sound to which he or she listens, which can help the user understand the sound. In this case, it is unnecessary to perform the measurement display in the actual time. When the measured result is displayed, the test signal may be reproduced. Namely, the sound signal processing apparatus 200 reproduces the signal at the time of starting of the animation, and stops the signal reproduction after the steady state passes to switch the state into the attenuation animation display. In addition, if the animation display of the actual sound change is performed in real time, it is difficult for the human to recognize it. Therefore, it is preferable to display the animation of the rise-up and fall-down parts in the slow state (e.g., substantially 1000 times msec of the actual time).

The present invention is not limited to the image display in real time with measuring of the sound signal. Namely, after the measurement of the sound signal of each channel, the image display may be simultaneously executed. In addition, the user can choose the above various kinds of display images by switching the mode of the display image.

Moreover, the present invention is not limited to the animation display only at the time of the measurement. Namely, the animation display may be performed in real time at the time of the normal sound reproduction. In this case, the animation is displayed by measuring the sound field with using a microphone, or by directly analyzing the signal of the source.

### INDUSTRIAL APPLICABILITY

The present invention is applicable to individual-use and business-use audio system and home theater.

1-10. (canceled)

11. A sound signal processing apparatus, comprising:
an obtaining unit which obtains a sound signal discriminated for each frequency band;
a color assignment unit which assigns color data, different for each frequency band, to the obtained sound signal;
a luminance change unit which generates data including a changed luminance of the color data, base on a level for each frequency band of the sound signal;
a color mixing unit which generates data obtained by totalizing data generated by the luminance change unit in all the frequency bands; and
a display image generating unit which generates image data for display on an image display device from data generated by the color mixing unit.

12. The sound signal processing apparatus according to claim 11, wherein, when the level for each frequency band of the sound signal is same, the color assignment unit sets the color data so that data obtained by totalizing all the color data shows a specific color.

13. The sound signal processing apparatus according to claim 12, wherein the display image generating unit generates the image data so that the image data and the specific color are simultaneously displayed.

14. The sound signal processing apparatus according to claim 11, wherein the color assignment unit sets the color data so that color variation of the color data corresponds to high/low of frequency of the frequency band.

15. The sound signal processing apparatus according to claim 11, wherein the luminance change unit changes the luminance of the color data in consideration of visual characteristics of a human.

16. The sound signal processing apparatus according to claim 11,
wherein the obtaining unit obtains the sound signal discriminated for each frequency band to each of output signals outputted from a speaker,
wherein the color assignment unit assigns the color data to each sound signal outputted from the speaker,
wherein the luminance change unit generates data including the changed luminance of the color data, based on each level of the sound signal outputted from the speaker,
wherein the color mixing unit generates data obtained by totalizing the output signal outputted from the speaker in all the frequency bands, and
wherein the display image generating unit generates the image data so that the data generated by the color mixing unit to each output signal outputted from the speaker is simultaneously displayed on the image display device.

17. The sound signal processing apparatus according to claim 16, wherein the display image generating unit generates the image data in which at least one of a luminance, an area and a measure of the image data displayed on the image display device is set, in correspondence with each level of the output signal outputted from the speaker.

18. The sound signal processing apparatus according to claim 16, wherein the display image generating unit generates the image data so that an image on which an actual arrangement position of the speaker device is reflected is displayed.

19. A computer program product in a computer-readable medium executed by a sound signal processing apparatus, comprising:
an obtaining unit which obtains a sound signal discriminated for each frequency band;
a color assignment unit which assigns color data, different for each frequency band, to the obtained sound signal;
a luminance change unit which generates data including a changed luminance of the color data, based on a level for each frequency band of the sound signal;
a color mixing unit which generates data obtained by totalizing data generated by the luminance change unit in all the frequency bands; and
a display image generating unit which generates image data for display of the data generated by the color mixing unit on the image display device.

20. A sound signal processing method, comprising:
an obtaining process which obtains a sound signal discriminated for each frequency band;
a color assignment process which assigns color data, different for each frequency band, to the obtained sound signal;
a luminance change process which generates data including a changed luminance of the color data, based on a level for each frequency band of the sound signal;
a color mixing process which generates data obtained by totalizing the data generated in the luminance change process in all the frequency bands; and
a display image generating process which generates image data for display on the image display device from data generated in the color mixing process.
